(19) United States
(12) Patent Application Publication
(10) Pub. No.: US 2016/0236050 A1
(43) Pub. Date: Aug. 18, 2016

(54) HOCKEY STICK BLADE AND METHOD OF MAKING SAME

(71) Applicant: Sport Maska Inc., Montreal (CA)

(72) Inventors: Eric ALLARD, St-Hubert (CA); Travis DOWNING, Carlsbad, CA (US)

(21) Appl. No.: 14/620,896

(22) Filed: Feb. 12, 2015

(51) Int. Cl. A63B 59/70; B05D 1/00; B29C 65/02

(52) U.S. Cl. CPC A63B 59/70; B29C 65/02; B05D 1/00; B29L 2031/52

(57) ABSTRACT

A blade for a hockey stick, having a body including an outer layer with an outer surface defining at least part of each of the impact surfaces of the body. A face member is made from a different material, has opposed inner and outer surfaces interconnected by a peripheral edge, and is embedded in the body such that the peripheral edge is in contact with the first material and at least a major part of the inner surface is in contact with the body. The outer surface of the face member defines part of the first impact surface. The outer surface of the face member is aligned with the outer surface of the outer layer adjacent the face member such that the first impact surface is continuous over a transition between the outer layer and the face member. A method for making a hockey stick blade is also discussed.

### TECHNICAL FIELD

The application relates generally to sporting equipment and, more particularly, to blades for hockey sticks.

### BACKGROUND

Conventional hockey sticks, such as those used for playing ice or street hockey, may have a blade made from fiber-reinforced composite materials. Although such fiber-reinforced composite materials are stiff in specific directions of load and are also light, other materials may have more desirable properties, for example under impact loads and in vibration damping response.

### SUMMARY

In one aspect, there is provided a blade for a hockey stick, comprising: a body adapted to be connected to the proximal end of a shaft, the body defining spaced apart first and second outer impact surfaces, each of the impact surfaces having a heel portion proximate a shaft connection point and a toe portion spaced apart from the shaft connection point, the body including an outer layer having an outer surface defining at least part of each of the first and second impact surfaces of the body, the outer layer made of a first material, the first material being a composite material; and a face member made from a second material different from the first material, the face member having opposed inner and outer surfaces interconnected by a peripheral edge, the face member overlaying and embedded in the body, the peripheral edge being in contact with the first material and at least a major part of the inner surface of the face member being in contact with the body of the blade, the outer surface of the face member defining part of the first impact surface of the body, the outer surface of the face member being aligned with the outer surface of the outer layer adjacent the face member such that the first impact surface of the body is continuous over a transition between the outer layer and the face member.

In another aspect, there is provided a method for making a hockey stick blade, comprising: positioning a face member over an outer surface of a layer of uncured composite material, the face member being made of a material different from the uncured composite material; putting the face member and the outer surface of the layer of uncured composite material extending around the face member in contact with a blade-shaped mold surface; and heating the uncured layer of composite material and applying pressure to the layer of uncured composite material against the mold surface until the face member is embedded in the layer of composite material and the composite material is cured.

### DESCRIPTION OF THE DRAWINGS

Reference is now made to the accompanying figures in which:

FIG. 1 is a schematic tridimensional view of a hockey stick, according to an embodiment of the present disclosure;

FIG. 2 is a cross-sectional view of a blade of the hockey stick of FIG. 1, taken along the line II-II;

FIGS. 3A-3E are schematic rear views of face members of a blade for a stick such as shown in FIG. 1, according to various embodiments of the present disclosure; and

FIGS. 3F-3G are schematic front views of hockey stick blades with face members, according to various embodiments of the present disclosure.

### DETAILED DESCRIPTION

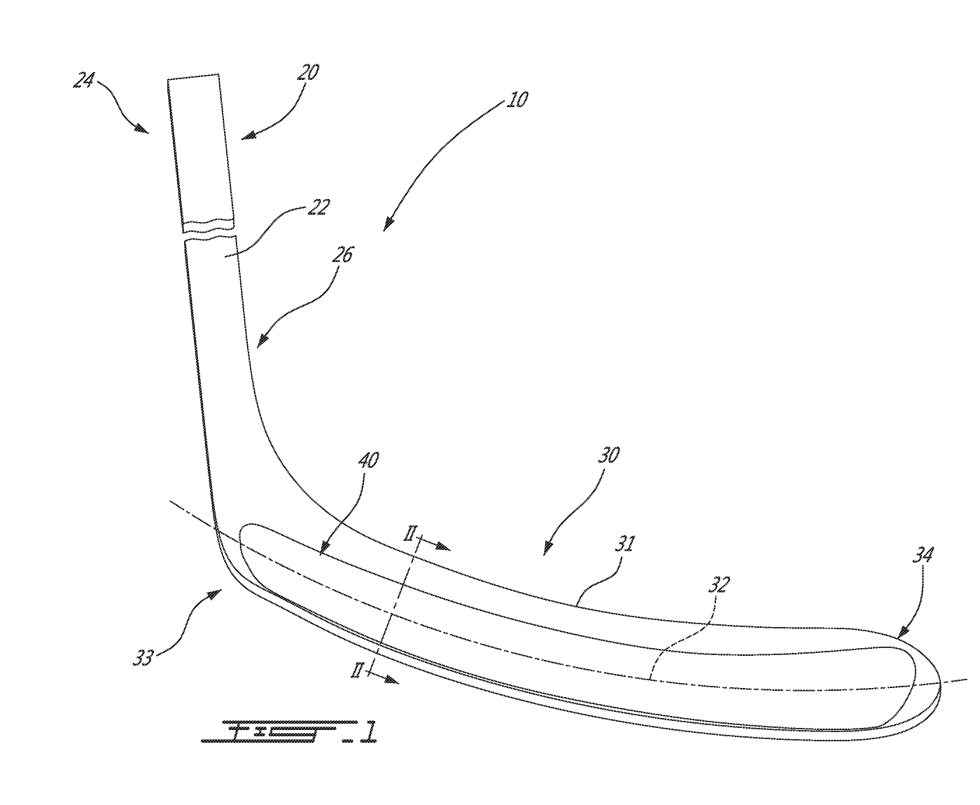

FIG. 1 illustrates generally a hockey stick 10 (or simply “stick 10”). The stick 10 can be used to play any suitable sport or activity, and is not strictly limited to the sport of ice hockey. The stick 10 has a generally elongated shaft 20 which can be manipulated by the user of the stick 10, a blade 30 which is adapted to contact an object such as a ball or puck, and a face member 40 which reinforces portions of the blade 30.

The shaft 20 joins, or is made integral with, the blade 30, thereby forming the stick 10. The shaft 20 is manipulated by the hands of the user in order to control the blade 30. The shaft 20 therefore has a shaft body 22, generally of a rectangular or oblong cross-section, which can be gripped by the user and which provides the corpus to the shaft 20. Specifically, the shaft body 22 extends between a distal end 24 and a proximal end 26. The distal end 24 corresponds to the free extremity of the shaft body 22, and the proximal end 26 corresponds to the extremity of the shaft body 22 which is connected to, or made integral with, the heel or neck of the blade 30. When the proximal end 26 is made integral with the blade 30, such as during the manufacturing process of the stick 10, the stick 10 is a one-piece, integral construction.

The shaft body 22, and thus the shaft 20, can take any suitable shape or have features and components which make it suitable for the activity for which it is used. For example, it may be desirous to reduce the weight of the shaft 20, which constitutes a major component of the overall weight of the stick 10. In such an instance, the shaft body 22 of the shaft 20 can be hollow so as to define an elongated body cavity. If it is desired to additionally reinforce the stiffness of shaft 20 while still providing the requisite flexibility, one or more longitudinal shaft ribs can be disposed within the body cavity, and extend between opposed interior walls of the shaft body 22. Each shaft rib can extend along some portion, or all, of the length of the shaft body 22 between the first end 24 and the second end 26. If so desired, one or more of the shaft ribs can be discontinuous along their length. It will therefore be appreciated that each shaft rib can reinforce the stiffness of the shaft body 22 along its length and/or along its width, while still providing the shaft body 22, and thus the shaft 20, with the desired amount of flexibility.

The blade 30 can be any suitable curved body which provides one or more impact surfaces to be used to manipulate the object. It can also be curved along its length to provide for improved manipulation of the object. Some portion, or all, of the blade 30 can be hollow in order to reduce the overall weight of the stick 10.

Still referring to FIG. 1, the blade 30 has a body 31 which forms the corpus of the blade 30 and provides structure thereto. The body 31 is an elongated object which extends along a blade axis 32 between a heel portion 33 proximate the connection with the shaft 20 and a toe portion 34 spaced apart from the connection with the shaft 20. The heel portion 33 generally defines a curved bottom edge of the body 31 which contacts the ice or playing surface when the stick 10 is in use. The toe portion 34 may otherwise be referred as the tip of the blade 30. The body 31 may also have a neck portion, which defined a connection point of the blade 30 in direct contact with the proximal end 26 of the shaft 20, and which is joined with this end so as to form the stick 10. The general shape of the blade 30 is defined between these components, in that the body 31 of the blade 30 extends between the heel portion 33 and the toe portion 34. It will be appreciated that the blade 30 can take shapes and configurations which differ from those shown in the figures.

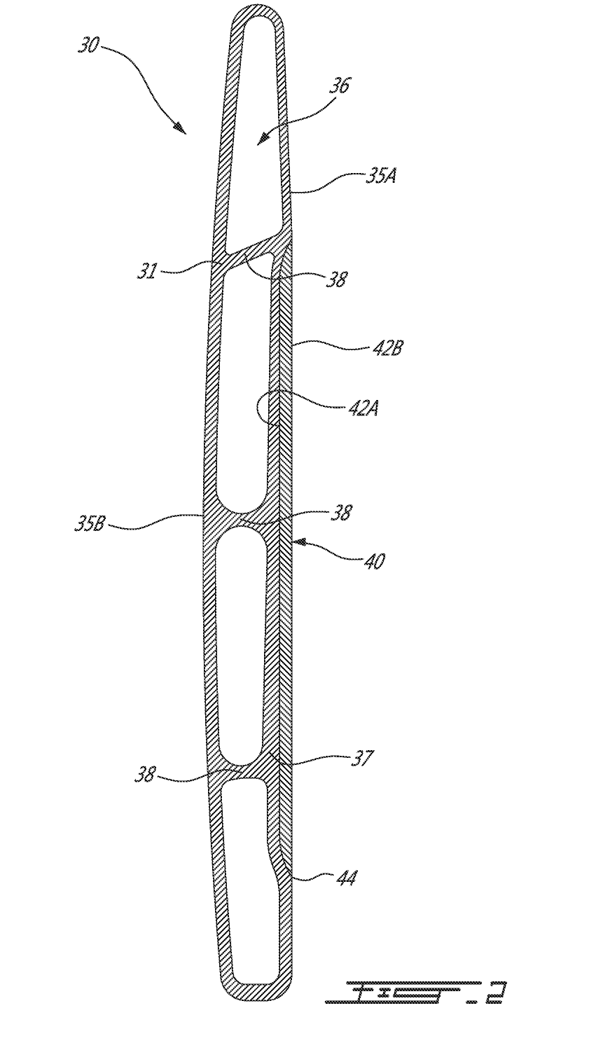

Referring now to FIG. 2, the body 31 defines spaced-apart first and second outer impact surfaces 35A, 35B. Each of the impact surfaces 35A, 35B is a contact surface for impacting the object and providing a force thereto. The impact surfaces 35A, 35B may be exposed to the environment, or covered by a protective coating, for example transparent. In the embodiment shown, the first impact surface 35A designates the “front” area of the body 31 which forms the primary contact surface with the object being manipulated, and is generally concave, while the second impact surface 35B is a “rear” surface, generally convex. Both the first and second impact surfaces 35A, 35B extend along the entirety of the body 31 and define part of the heel portion 33 and of the toe portion 34. The curvature and shape of the impact surfaces 35A, 35B therefore defines that of the blade 30.

The body 31 has an outer material layer 37. In a particular embodiment, the outer material layer 37 is made of composite material, and may be formed of a single or multiples connected plies of composite materials, with the multiple plies disposed in side by side and/or overlaying relationship. In the embodiment shown, the body 31 has an inner blade cavity 36 and the outer material layer 37 circumscribes this inner blade cavity 36. The inner blade cavity 36 may be hollow; alternately, the inner blade cavity 36 may be filed with an appropriate type of material, for example an appropriate type of foam including, but not limited to, PVC or polyurethane foam. The outer material layer 37 delimits the thickness, length, and height of the inner blade cavity 36 within the body 31. The outer surface of the outer material layer 37 forms at least part of each of the outer impact surfaces 35A, 35B. In the embodiment shown, the outer surface of the outer material layer 37 corresponds to the entire second impact surface 35B and to a peripheral portion of the first impact surface 35A, as will be further detailed below.

The outer material layer 37 may include any appropriate type of composite material, including, but not limited to, suitable fiber-reinforced polymers, for example fiber-reinforced epoxy. In a particular embodiment, the outer material layer 37 is made of an epoxy/carbon fiber material. In general, the outer material layer 37 consists of a fiber portion and a resin portion, the resin portion serving as a matrix in which the fibers are embedded in a defined manner. In a composite for hockey stick blades, for example, the composite material may be provided in prepreg form, superposed in a “lay-up” manner and then cured to a rigid condition using heat and pressure.

Still referring to FIG. 2, the blade 30 may have one or more internal ribs 38 spanning the inner blade cavity 36. Each internal rib 38 reinforces the stiffness of the body 31 between the first and second impact surfaces 35A, 35B while helping to reduce the overall weight of the blade 30, and thus the overall weight of the stick 10. Each internal rib 38 may extend longitudinally along the blade axis between the heel portion and the toe portion. Alternatively, each internal rib 38 may extend transverse to the blade axis between the top and bottom edges of the body 31. Irrespective of its orientation, each internal rib 38 forms a bridge between opposed inner surfaces of the outer material layer 37, and can be formed during the making of the blade 30 using any suitable technique. In a particular embodiment, each internal rib 38 is made of the same composite material as the outer material layer 37; alternately, different materials may be used. The internal rib 38 can consist of a single, substantially uninterrupted body. Alternately, a number of discrete internal ribs 38 can be used forming rib sections which are spread apart. Each rib section divides the inner blade cavity 36 into separate hollow channels.

Still referring to FIG. 2, the blade includes at least one face member 40 made of a material different from that of the outer material layer 37. The material of the face member(s) 40 is selected depending on the property of the blade 30 which is designed to be tailored by it. For example, the material of the face member(s) may be more rigid in torsion and/or bending, more resistant to cracks, have increased vibration dampening properties, and/or have a more isotropic rigidity than the material of the outer material layer 37. In a particular embodiment, each face member 40 provides a localized zone of increased reinforcement over the portion of the body 31 where it is located. Such reinforcement may provide for an increased durability of the blade 30, a better feel and control of the blade 30 by users of the stick 10, and/or a modification of the stiffness and torsional rigidity of the blade 30, for example. Some examples of suitable materials for the face member 40 include composite materials different from that of the outer material layer 37, ceramics, ceramic matrix composites (CMC), polymer/elastomer materials, organic materials, metals, alloys, metal matrix composites (MMC), etc. In a particular embodiment, the face member 40 is made of a metal material, for example 6-4 titanium alloy (α-β Ti) or 7075 aluminum alloy, such as to provide suitable isotropic rigidity properties which help to stiffen the blade 30 in both bending and torsion efficiently. Therefore, using a metal material for the face member 40 represents a potential upgrade in blade durability and responsiveness due to the isotropic properties of metal materials.

Each face member 40 has an inner surface 42A and an outer surface 42B spaced apart from one another across the thickness of the face member 40, and a peripheral edge 44 interconnecting the inner and outer surfaces 42A, 42B. In the embodiment shown, the face member 40 is embedded in the body 31 by being embedded in the outer material layer 37: at least a major part of the peripheral edge 44 and of the inner surface 42A are in contact with the material of the outer material layer 37. In the embodiment shown in FIG. 2, the entirety or substantially the entirety of the peripheral edge 44 and of the inner surface 42A are in contact with the material of the outer material layer 37.

In a particular embodiment, the peripheral edge 44 is bevelled, such that the perimeter of the inner surface 42A is smaller than the perimeter of the outer surface 42B, which may facilitate contact between the peripheral edge 44 and the outer material layer 37. In a particular embodiment, the material of the outer material layer 37 may extend over a periphery of the face member 40, such that only a central portion of the face member 40 is exposed and visible. In the embodiment shown, the outer surface 42B of the face member 40 defines part of the first impact surface 35A, surrounded by the outer material layer 37 defining the remaining part of the first impact surface 35A.

The outer surface 42B of the face member 40 is aligned with the adjacent outer surface of the outer material layer 37, such that the first impact surface 35A is continuous over the transition between the outer material layer 37 and the face member 40. The outer surface 42B of the face member 40 is therefore flush or level with the adjacent outer surface of the outer material layer 37, and is thus able to enter into contact with the playing object.

Although a single face member 40 is shown, the blade 30 may alternately include two or more face members embedded in the body 31, each defining a part of one of the impact surfaces 35A, 35B. The face member 40 may also include multiple layers of material embedded in the body 31.

In a particular embodiment, the blade 30 is integrally formed. The expression “integrally formed” refers to the relationship between the face member(s) 40 and the materials of the body 31 (outer material layer 37, foam if applicable), in that the face member(s) 40 are embedded in the body 31, for example in the outer material layer 37, during its molding process, incorporating the face member(s) 40 in the cured material layer 37 in the finished blade 30. In a particular embodiment, such an integral construction reinforces the bond between the material layer 37 and face member(s) 40 to reduce the chances of detachment of the face member(s) 40 during use, for example by contrast to heads for striking objects where a reinforcement piece is adhered or otherwise applied separately to the head after it has been manufactured.

In the embodiment of FIGS. 1-2, the face member 40 extends along a direction which is transverse to the longitudinal blade axis to span across one or more internal ribs 38. The relationship between the face member 40 and the internal ribs 38 may vary. For example, the face member 40 may overlay a portion of the outer material layer 37 spanning across two internal ribs 38, each rib 38 extending near opposite ends of the face member 40. The face member 40 may overlay a portion of the outer material layer 37 spanning across three internal ribs 38, for example two ribs 38 extending near opposite ends of the face member 40, and a third rib 38 disposed between these two ribs 38.

In an embodiment where the internal cavity 36 is filled with foam, the face member 40 may be embedded in the body 31 by being embedded in the outer material layer 37, such that at least a major part (and preferably, the entirety or substantially the entirety) of the peripheral edge 44 and of the inner surface 42A are in contact with the material of the outer material layer 37—i.e., the outer material layer 37 extends between the face member 40 and the foam. Alternately, the face member 40 may be embedded in the body 31 by having at least a major part (and preferably, the entirety or substantially the entirety) of the peripheral edge 44 in contact with the material of the outer material layer 37, the outer material layer 37 optionally overlapping a periphery of the outer surface 42B of the face member 40, and with that at least a major part (and preferably, the entirety or substantially the entirety) of the inner surface 42A supported by and in contact with the foam and with the ribs 38 if such are present.

In a particular embodiment, having the face member 40 embedded in the body 31 allows for the face member 40 to have a greater impact on the properties of the body 31, for example in contrast to heads for striking objects where the reinforcement piece is applied only against inner ribs spanning a hollow cavity of the head.

It has been observed that putting a metal material between the playing object and the composite material of the blade face has positive performance aspects in terms of user perception. Users have experienced a noticeable feel improvement when the material of some or all of the blade face is changed. In a particular embodiment, damping and impact toughness is taken up by the metal material of the face member 40, while the composite material of the blade 30 makes the blade 30 stiff in specific directions of load.

It can thus be appreciated that the one or more face member(s) 40 can assume different shapes and configurations in order to achieve such functionality. For example, the face member 40 may extend along the periphery of the body 31 along the top and/or bottom edges thereof, in the toe portion and/or the heel portion of the blade 30, depending on the property(ies) of the blade to be tailored by the face member(s) 40—i.e. wear resistance, stiffness, impact resistance, vibration dampening, etc.

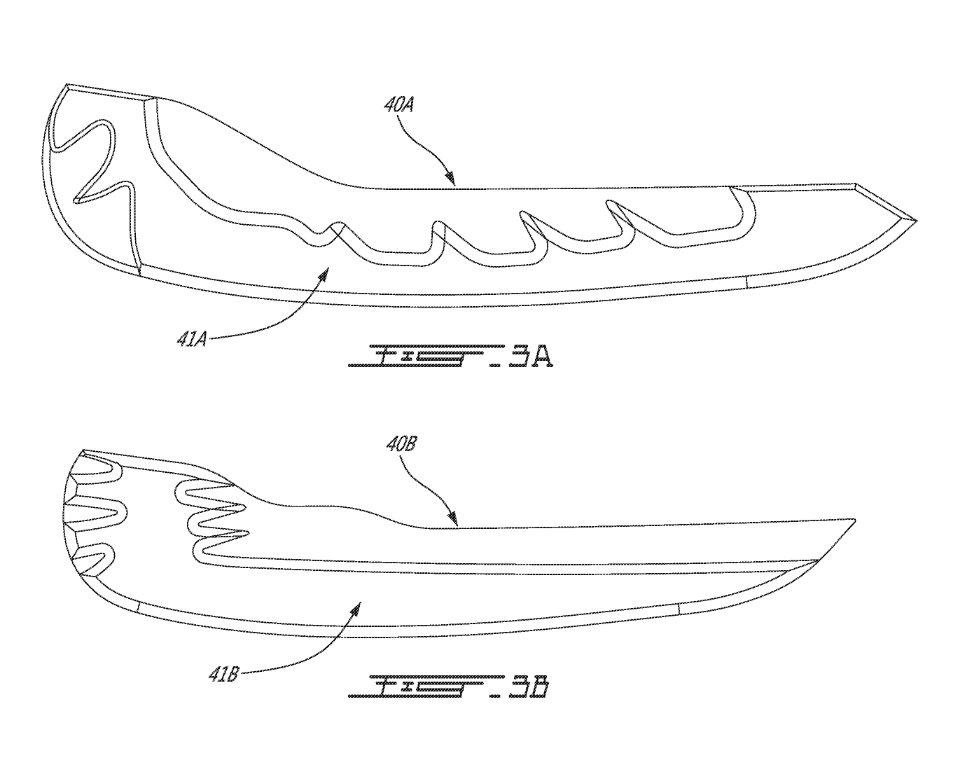

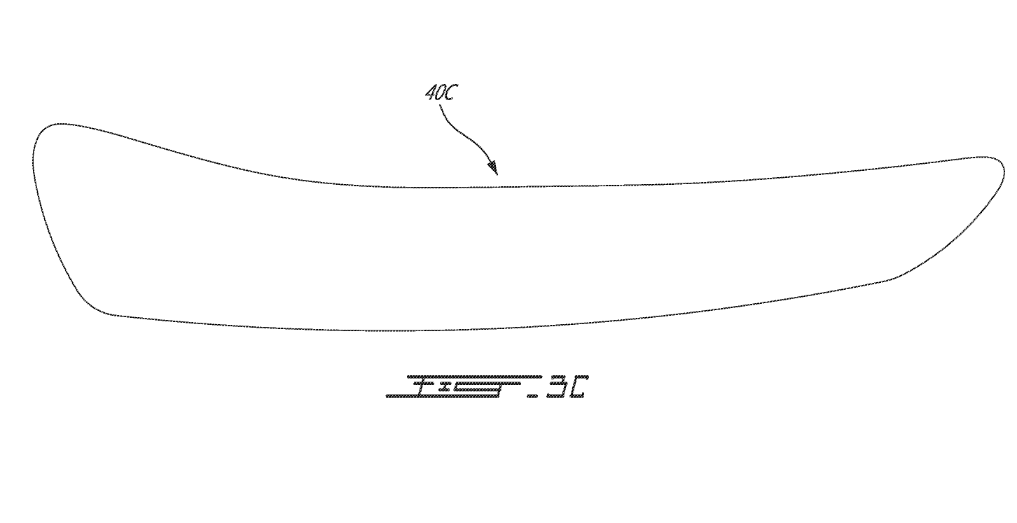

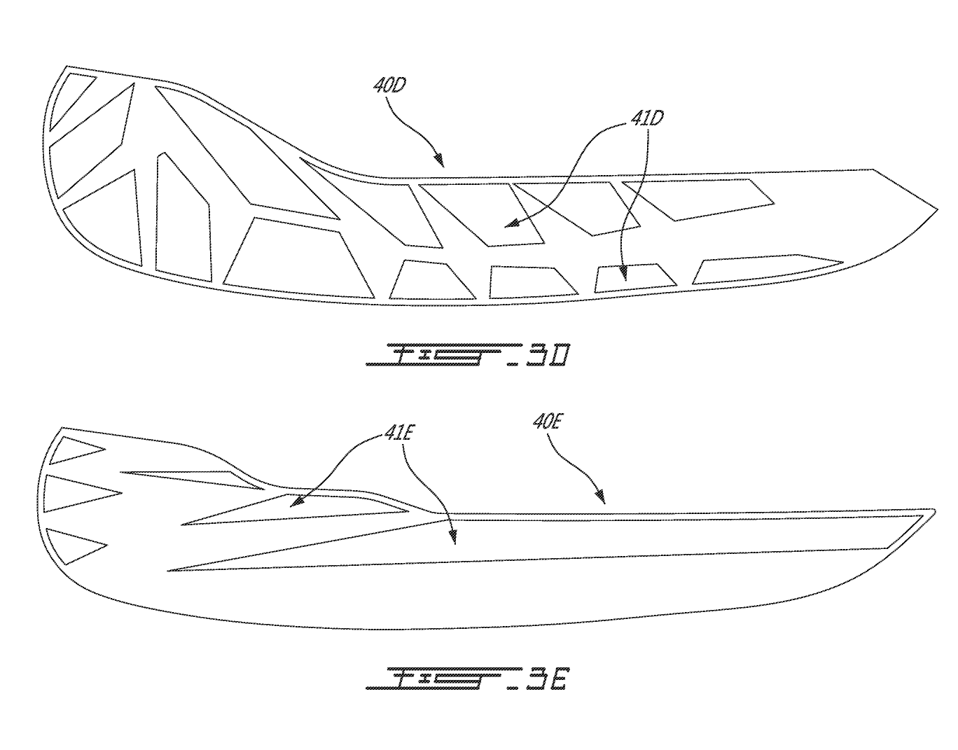

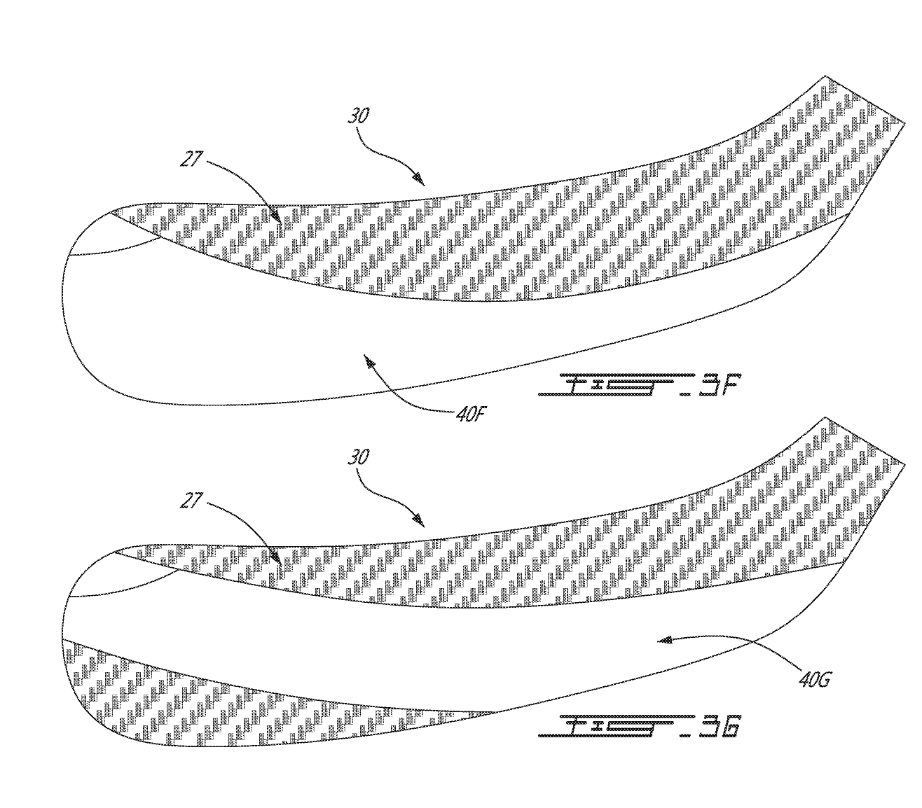

Referring to FIG. 3A, an alternate configuration for the face member 40A is shown. The Figure shows the inner surface which is to be received against the body 31 (for example against the outer material layer 37). The face member 40A is shaped as a varying thickness metal plate extending longitudinally along a length of the body of the blade between the heel portion and the toe portion. As can be seen, the inner surface of the face member 40A includes a central protuberance 41A forming a zone of increased thickness with respect to a remainder of the face member 40A. The protuberance 41A has an irregular shape and extends along the length of the length of the face plate 40. The protuberance 41A may help to reinforce those regions of the outer impact surface 35A of the blade 30 which are most often in contact with the playing object. In a particular embodiment, the shape of the protuberance is determined to correspond to regions of highest load or highest deflection in the blade 30 under particular constraint conditions.

Referring to FIG. 3B, another alternate configuration for the face member 40B is shown. As for the previous embodiment, the Figure shows the inner surface which is to be received against the body 31 (for example against the outer material layer 37). The face member 40B is shaped as a varying thickness metal plate extending longitudinally along a length of the body of the blade between the heel portion and the toe portion. As can be seen, the inner surface of the face member 40B also includes a central protuberance 41B forming a zone of increased thickness with respect to a remainder of the face member 40B. The protuberance 41B has an irregular shape and extends along the length of the length of the face plate 40, covering more of the toe portion that that of the previous embodiment. The shape of the protuberance 41B may be determined to correspond to regions of highest load or highest deflection in the blade 30 under particular constraint conditions different from those of the previous embodiment.

Referring to FIG. 3C, in another alternate configuration for the face member 40C, both the inner and outer surfaces may be smooth, defining a thickness of the face member 40C which is uniform along its length, and accordingly may be easier to manufacture than the face members 40A, 40B.

Referring to FIG. 3D, another alternate configuration for the face member 40D is shown. As for the previous embodiments, the Figure shows the inner surface which is to be received against the body 31 (for example against the outer material layer 37). The metal face member 40D is shaped as a plate extending longitudinally along a length of the body of the blade between the heel portion and the toe portion, with the inner surface including multiple reinforcement blocks 41D forming local zone of increased thickness with respect to a remainder of the face member 40D. The thickness of the reinforcement blocks 40D can be uniform or vary between blocks 40D.

Referring to FIG. 3E, another alternate configuration for the face member 40E is shown. As for the previous embodiments, the Figure shows the inner surface which is to be received against the body 31 (for example against the outer material layer 37). The metal face member 40E includes another configuration of plate and reinforcement blocks 41E forming local zone of increased thickness with respect to a remainder of the face member 40D. The thickness of the reinforcement blocks 40E can be uniform or vary between blocks 40E. “Lattice”-like configuration such as the face members 40D, 40E may be easier to manufacture than the configurations of FIGS. 3A and 3B.

In the embodiments of FIGS. 3A-3E, the outer surface of the face member, which in use is the visible surface, may be smooth or alternately be provided with a textured pattern, or with raised features defining a variation in thickness, for example similarly to the inner surface.

FIG. 3F shows an alternate configuration for the face member 40F, shown here embedded in the outer material layer 37 to define the body of the blade 30. It can be seen that the face member 40F, which can have an inner surface with any of the above-described configurations, extends from the bottom edge of the blade 30 along the entire length of the blade, covers a majority of the toe portion and only a small part of the heel portion, while the top portion of the blade 30 is free from the face member 40F. In a particular embodiment, such a configuration used with a face member 40F made of metal material provides for increased stiffness in bending and torsion, by comparison with a similar blade made only with the composite material.

FIG. 3G shows another alternate configuration for the face member 40G, also shown embedded in the outer material layer 37 to define the body of the blade 30. It can be seen that the face member 40G extends from the bottom edge of the blade 30 in the heel portion only, forming a band coming higher in the toe portion such that the top and bottom edges of the blade in the toe portion are left uncovered. In a particular embodiment, such a configuration used with a face member 40F made of metal material provides for increased stiffness in torsion, by comparison with a similar blade made only with the composite material.

The shape of the face member can thus be selected in accordance with the property of the body 31 to be changed, for example the stiffness in torsion and/or bending.

There is also disclosed herein a method for making a hockey stick blade, such as the one described herein. The method involves the use of a mold, and curing using heat and pressure.

In a particular embodiment, the outer material layer 37 is formed in its uncured state by one or more plies of prepreg wrapped around a bladder, or around a foam core; in the case of a blade with internal ribs, multiple bladders/foam cores may be individually wrapped with prepreg material to define the ribs, and the wrapped bladders/foam cores are then wrapped together with prepreg material to form the outer material layer 37. The face member is positioned over the uncured outer material layer 37, or against the foam core and surrounded by the outer material layer 37.

To facilitate bonding between the face member and the composite material layer or foam underneath it, the inner surface of the face member may be abraded prior to assembly. Adhesive can also be added between the face member and composite material layer or foam, for example in the form of an adhesive resin film.

The face member and uncured outer material layer adjacent to it are then put into contact with a mold surface defining the desired shape for the blade impact surface. The mold surface typically forms part of a mold enclosure which encloses the uncured composite material wrapped around the bladder(s)/foam core(s) together with the face member to form the blade.

The uncured outer material layer 37 is heated while pressing it against the mold surface, for example by inflating the bladder(s) and/or applying pressure with the mold surfaces. As it is heated, the composite material first softens, and the pressure and heat allow the face member to “sink” and become embedded in the outer material layer 37; the face member and composite material around it being pressed against the mold surface ensuring the formation of a continuous impact surface. The assembled composite material and face member are heated and compressed until the composite material is cured, the face member remaining embedded in it.

In embodiments where bladders are used, the cavities created in the cured blade when the bladders are removed may be filled with material such as expandable foam, or alternately may remain hollow.

In a particular embodiment, the face member is made of a material that is in desired or cured state before assembly with the uncured outer material layer, for example a metal, an alloy, or a cured composite material. In another embodiment, the face member is made of another material that is uncured or partially cured, and reaches its desired cured state simultaneously with the curing of the outer material layer.

A coating, for example a clear protective coating, may be applied over the impact surfaces of the cured blade, for example for increased durability.

Alternate methods of fabrication are also possible.

It can thus be appreciated from the above disclosure that the potential structural benefits of providing a metal face member allows to gain some advantages of having a metal blade without the weight penalty associated with having an all-metal blade. Indeed, fiber-reinforced composite material is stiff and light, but is inferior to metal under impact loads and in vibration damping response. Utilizing metal and composite to their respective strengths therefore contributes to improving blade performance.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A blade for a hockey stick, comprising:
a body adapted to be connected to the proximal end of a shaft, the body defining spaced apart first and second outer impact surfaces, each of the impact surfaces having a heel portion proximate a shaft connection point and a toe portion spaced apart from the shaft connection point, the body including an outer layer having an outer surface defining at least part of each of the first and second impact surfaces of the body, the outer layer made of a first material, the first material being a composite material; and
a face member made from a second material different from the first material, the face member having opposed inner and outer surfaces interconnected by a peripheral edge, the face member overlaying and embedded in the body, the peripheral edge being in contact with the first material and at least a major part of the inner surface of the face member being in contact with the body of the blade, the outer surface of the face member defining part of the first impact surface of the body, the outer surface of the face member being aligned with the outer surface of the outer layer adjacent the face member such that the first impact surface of the body is continuous over a transition between the outer layer and the face member.

2. The blade as defined in claim 1, wherein an entirety or substantially the entirety of the inner surface of the face member is in contact with the body of the blade.

3. The blade as defined in claim 1, wherein the face member overlays and is embedded in the outer layer such that the peripheral edge and the at least major part of the inner surface are in contact with the first material

4. The blade as defined in claim 3, wherein an entirety or substantially the entirety of the inner surface of the face member is in contact with the first material.

5. The blade as defined in claim 1, wherein the second material is a metal.

6. The blade as defined in claim 1, wherein the blade has different rigidity in one or both of torsion and bending when compared to the body of the blade without the face member embedded therein.

7. The blade as defined in claim 1, wherein the second material is more resistant to cracks than the first material.

8. The blade as defined in claim 1, wherein the second material has increased vibration dampening properties when compared to the first material.

9. The blade as defined in claim 1, wherein the second material has an isotropic rigidity and the first material has non-isotropic rigidity.

10. The blade as defined in claim 1, wherein the face member extends longitudinally from the heel portion to the toe portion.

11. The blade as defined in claim 1, wherein the blade has an internal cavity surrounded by the outer layer, the cavity spanned by a plurality of spaced apart internal ribs extending longitudinally between the heel portion and the toe portion, the ribs interconnecting opposed inner surfaces of the outer layer, the face member overlays a portion of the body spanning across at least two internal ribs.

12. The blade as defined in claim 1, wherein the outer surface of the face member is smooth.

13. The blade as defined in claim 1, wherein the inner surface of the face member includes at least one protuberance, such that the face member has a varying thickness.

14. The blade as defined in claim 1, wherein the face member extends to at least one edge of the body.

15. The blade as defined in claim 1, further comprising a coating over the impact surfaces of the body.

16. A hockey stick comprising:
a shaft having a proximal end and a distal end opposite the proximal end; and
a blade as defined in claim 1 connected to the proximal end of the shaft.

17. A method for making a hockey stick blade, comprising:
positioning a face member over an outer surface of a layer of uncured composite material, the face member being made of a material different from the uncured composite material;
putting the face member and the outer surface of the layer of uncured composite material extending around the face member in contact with a blade-shaped mold surface; and
heating the uncured layer of composite material and applying pressure to the layer of uncured composite material against the mold surface until the face member is embedded in the layer of composite material and the composite material is cured, an outer surface of the cured composite material surrounding the face member being aligned with an outer surface of the face member to form a continuous surface.

18. The method as defined in claim 17, wherein positioning the face member over the outer surface includes applying an adhesive between the face member and the outer surface.

19. The method as defined in claim 17, wherein the layer of uncured composite material is wrapped around at least one bladder, and applying pressure is performed by inflating the at least one bladder.

20. The method as defined in claim 17, further comprising applying a coating over the cured composite material and face member.
